(19) United States
(12) Patent Application Publication
(10) Pub. No.: US 2018/0285014 A1
(43) Pub. Date: Oct. 4, 2018

(54) DATA STORAGE METHOD AND APPARATUS

(71) Applicant: HUAWEI TECHNOLOGIES CO., LTD., SHENZHEN (CN)

(72) Inventors: Fulu LI, Shenzhen (CN); Chengwei ZHANG, Chengdu (CN); Pei XU, Chengdu (CN)

(21) Appl. No.: 16/002,585

(22) Filed: Jun. 7, 2018

Related U.S. Application Data
(63) Continuation of application No. PCT/CN2015/096696, filed on Dec. 8, 2015.

(51) Int. Cl. G06F 3/06

(52) U.S. Cl. CPC G06F 3/0641; G06F 3/0673; G06F 3/0608

(57) ABSTRACT

A data storage method includes: separately dividing a data block and a reference data block into N equal-sized sub-data blocks, comparing a sub-data block and a reference sub-data block corresponding to a same location identifier, determining, in the N sub-data blocks, a sub-data block that can be deduplicated and a sub-data block that cannot be deduplicated, performing a deduplication operation on the sub-data block that can be deduplicated, selecting a representative sub-data block of the sub-data block that cannot be deduplicated, performing an exclusive OR operation on data of the sub-data block that cannot be deduplicated and data of the representative sub-data block, compressing a result of the exclusive OR operation using run-length encoding, and storing a compression result and location information of the sub-data block that cannot be deduplicated.

### CROSS-REFERENCE TO RELATED APPLICATIONS

This application is a continuation of International Application No. PCT/CN2015/096696, filed on Dec. 8, 2015, which is hereby incorporated by reference in its entirety.

### TECHNICAL FIELD

Embodiments of the present application relate to the field of computers, and in particular, to a data storage method and apparatus.

### BACKGROUND

With an explosive increase of an amount of digital information, data occupies increasingly large space. As data exponentially increases, an enterprise faces ever-increasing time points for fast backup and recovery. Consequently, costs of managing stored data become increasingly high, more data center space is to be occupied, and energy consumption becomes increasingly large. It is found through research that up to 60% of data stored in an application system is redundant, and as time goes by, there is an increasingly large data redundancy ratio.

To alleviate a space increase problem in a storage system, reduce data occupation space and costs, and fully use an existing resource, a data deduplication technology becomes a hot research topic. Utilization of storage space may be optimized by using the data deduplication technology (referred to as “deduplication” below), to eliminate a duplicate file or data block distributed in the storage system. In addition, an amount of data transmitted in a network may be reduced by using the data deduplication technology, so that energy consumption and network costs are reduced, and a large amount of network bandwidth is saved for data replication.

With development of the data deduplication technology, the technology is widely applied to storage backup and file systems. A data deduplication module in the systems is responsible for comparing and analyzing data content, and finding redundant data. For data that repeatedly appears, only a location of stored duplicate data that can be used for reference needs to be recorded, and finally only data that does not repeatedly appear is stored in a storage medium.

In the prior art, all deduplication algorithms with a relatively good compression effect have a relatively large calculation amount, and deduplication algorithms with a small calculation amount have a relatively poor compression effect. It is found through research that there is a relatively high similarity between data blocks in a database application. Therefore, a valid storage algorithm is required to compress data in the database application.

### SUMMARY

In view of this, embodiments of the present application provide a data storage method and apparatus, so as to deduplicate and compress a data block to be stored, and reduce storage space required for storing the to-be-stored data block.

According to a first aspect, this application provides a data storage method, including:
dividing a data block to be stored into N equal-sized sub-data blocks, where the N sub-data blocks are corresponding to N location identifiers, each sub-data block is corresponding to one location identifier, and N is a positive integer greater than 1; selecting one of at least two stored comparison data blocks as a reference data block, where the reference data block includes N reference sub-data blocks, the N reference sub-data blocks are corresponding to the N location identifiers, and each reference sub-data block is corresponding to one location identifier; comparing a sub-data block corresponding to an i^{th} location identifier and a reference sub-data block corresponding to the i^{th} location identifier, and determining a first sub-data block in the N sub-data blocks, where i is a positive integer progressively increasing from 1 to N, and the first sub-data block is a sub-data block different from a compared reference sub-data block; selecting a representative sub-data block of the first sub-data block; performing an exclusive OR (XOR) operation on data of the first sub-data block and data of the representative sub-data block; and compressing a result of the XOR operation using run-length encoding, and storing a compression result and location information of the first sub-data block.

In a specific implementation process, because the data block and the reference data block have the same size, the sub-data block and the reference sub-data block also have the same size, and a ranking of a sub-data block in a data block may be used as the location identifier. For example, according to a location sequence, a location identifier of an i^{th} sub-data block is “i”. A sub-data block and a reference sub-data block that are corresponding to the same location identifier are compared, that is, a sub-data block and a reference sub-data block that are at the same location are compared.

In one embodiment, the method further includes: determining a second sub-data block in the N sub-data blocks by comparing a sub-data block and a reference sub-data block that are corresponding to the same location identifier, where the second sub-data block is a sub-data block the same as a compared reference sub-data block; and performing a deduplication operation on the second sub-data block.

According to features of data similarity and location correlation in a database, a data block to be stored is divided into sub-data blocks of a smaller granularity, sub-data blocks of the data block and a reference data block at a same location are compared, a deduplication operation is performed on same sub-data blocks with a relatively small calculation amount, an XOR operation is performed on a sub-data block and a reference sub-data block that are different from each other, and run-length encoding compression is performed on an XOR result. Therefore, storage space required for recording the data block is greatly reduced.

In one embodiment, the comparing a sub-data block corresponding to an i^{th} location identifier and a reference sub-data block corresponding to the i^{th} location identifier includes: comparing a fingerprint of the sub-data block corresponding to the i^{th} location identifier and a fingerprint of the reference sub-data block corresponding to the i^{th} location identifier, where if the fingerprints are the same, it indicates that the sub-data block is the same as the reference sub-data block, or if the fingerprints are different, it indicates that the sub-data block is different from the reference sub-data block.

Fingerprints of sub-data blocks are compared, thereby avoiding comparison performed on a bit basis when the sub-data blocks are compared. Therefore, comparison operation complexity is reduced.

In one embodiment, the selecting one of at least two stored comparison data blocks as a reference data block includes: selecting, from the at least two comparison data blocks as the reference data block, a comparison data block that has a largest quantity of sub-data blocks the same as those in the data block. Further, a comparison data block that has a largest quantity of sub-data blocks the same as those in the to-be-stored data block and that has a smallest quantity of clusters of different sub-data blocks may be selected as the reference data block. A cluster of different sub-data blocks is a set of different sub-data blocks that are continuous in locations, and sub-data blocks at adjacent locations of the set are same sub-data blocks.

The data block to be stored is compared with multiple comparison data blocks, so that a similarity between each comparison data block and the data block can be determined. A comparison data block that has a largest quantity of sub-data blocks the same as those in the to-be-stored data block is a data block that has a highest similarity with the to-be-stored data block. Further, a comparison data block that has a smallest quantity of clusters of different sub-data blocks is selected as the reference data block from comparison data blocks that have a highest similarity with the to-be-stored data block, so that information required for recording locations of different sub-data blocks can be reduced, and a deduplication operation compression ratio is further increased.

In one embodiment, the selecting a representative sub-data block of the first sub-data block includes: selecting a reference sub-data block that is corresponding to a location identifier that is corresponding to each first sub-data block as the representative sub-data block of the first sub-data block.

Data blocks stored in a database have a higher similarity with each other, and a same part of different data blocks generally has a same relative location in the data blocks. Therefore, the reference sub-data block that is corresponding to the location identifier that is corresponding to each first sub-data block is selected as the representative sub-data block of the first sub-data block, so that a large quantity of continuous “0s” can appear in an XOR result, and a run-length encoding compression ratio is greatly reduced.

In one embodiment, the selecting a representative sub-data block of the first sub-data block includes: separately performing an XOR operation on the first sub-data block and at least two stored sub-data blocks, and selecting a stored sub-data block as the representative sub-data block according to run-length encoding compression ratios of results of the XOR operations, where a result of XOR performed on the stored sub-data block and the first sub-data block has a smallest run-length encoding compression ratio.

The stored sub-data block is selected as the representative sub-data block from stored sub-data blocks by means of comparison, where a result of an XOR operation performed on the first sub-data block and the stored sub-data block has the smallest run-length encoding compression ratio, so that storage space required for storing the data block can be reduced to a relatively large extent.

In one embodiment, the selecting a representative sub-data block of the first sub-data block includes: performing an XOR operation on every two first sub-data blocks, and selecting a first sub-data block as the representative sub-data block according to run-length encoding compression ratios of results of the XOR operations, where a result of XOR performed on the first sub-data block and another first sub-data block has a smallest run-length encoding compression ratio.

The first sub-data blocks are searched for the first sub-data block that has a highest similarity with the another first sub-data block, and the first sub-data block is used as the representative sub-data block, so that storage space required for storing the to-be-stored data block can be reduced without depending on stored sub-data blocks.

In one embodiment, before the dividing a data block to be stored into N equal-sized sub-data blocks, the method further includes: extracting a sample from data to be stored, separately determining a storage compression ratio, a storage speed, and a read speed of the sample according to different sub-data block sizes, and determining a value of N according to a size of a sub-data block with a smallest storage compression ratio if the storage speed and the read speed meet a constraint condition, where the constraint condition is that the storage speed is greater than or equal to a first preset threshold, and the read speed is greater than or equal to a second preset threshold.

A most proper data block division method is selected by extracting the sample, so that storage space required for storing the data block can be reduced to a greatest extent when the storage processing speed and the read processing speed are met a constraint condition.

In one embodiment, the method further includes: storing a fingerprint of the first sub-data block. Therefore, when the first sub-data block is subsequently used as a reference sub-data block of another data block, there is no need to repeatedly calculate the fingerprint.

According to a second aspect, this application provides a computer readable medium, including a computer-executable instruction, where when a processor of a computer executes the computer-executable instruction, the computer executes the method in any one of the first aspect or the possible implementations of the first aspect.

According to a third aspect, this application provides a computing device, including a processor, a memory, a bus, and a communications interface, where the memory is configured to store an execution instruction, the processor and the memory are connected by using the bus, and when the computing device runs, the processor executes the execution instruction stored in the memory, so that the computing device executes the method in any one of the first aspect or the possible implementations of the first aspect.

According to a fourth aspect, this application provides a data storage apparatus, including: a division unit configured to divide a data block to be stored into N equal-sized sub-data blocks, where the N sub-data blocks are corresponding to N location identifiers, each sub-data block is corresponding to one location identifier, and N is a positive integer greater than 1; a selection unit configured to select one of at least two stored comparison data blocks as a reference data block, where the reference data block includes N reference sub-data blocks, the N reference sub-data blocks are corresponding to the N location identifiers, and each reference sub-data block is corresponding to one location identifier; a comparison unit configured to: compare a sub-data block corresponding to an i^{th} location identifier and a reference sub-data block corresponding to the i^{th} location identifier, and determine a first sub-data block in the N sub-data blocks, where i is a positive integer progressively increasing from 1 to N, and the first sub-data block is a sub-data block different from a compared reference sub-data block, where the selection unit is further configured to select a representative sub-data block of the first sub-data block; a calculation unit configured to perform an XOR operation on data of the first sub-data block and data of the representative sub-data block; and a compression unit, configured to: compress a result of the XOR operation using run-length encoding, and store a compression result and location information of the first sub-data block.

In a specific implementation process, because the data block to be stored and the reference data block have the same size, the to-be-stored sub-data block and the reference sub-data block also have a same size, and a ranking of a sub-data block in a data block may be used as the location identifier. For example, according to a location sequence, a location identifier of an i^{th} to-be-stored sub-data block is “i”. A to-be-stored sub-data block and a reference sub-data block that are corresponding to a same location identifier are compared, that is, a to-be-stored sub-data block and a reference sub-data block that are at a same location are compared.

In one embodiment, the apparatus further includes a deduplication unit; the comparison unit is further configured to determine a second sub-data block in the N sub-data blocks, where the second sub-data block is a sub-data block the same as a compared reference sub-data block; and the deduplication unit is configured to perform a deduplication operation on the second sub-data block.

According to features of data similarity and location correlation in a database, a data block to be stored is divided into sub-data blocks of a smaller granularity, sub-data blocks of the to-be-stored data block and a reference data block at a same location are compared, a deduplication operation is performed on same sub-data blocks with a relatively small calculation amount, an XOR operation is performed on a sub-data block and a reference sub-data block that are different from each other, and run-length encoding compression is performed on an XOR result. Therefore, storage space required for recording the to-be-stored data block is greatly reduced.

In one embodiment, the comparison unit is specifically configured to compare a fingerprint of the to-be-stored sub-data block corresponding to the i^{th} location identifier and a fingerprint of the reference sub-data block corresponding to the i^{th} location identifier, where if the fingerprints are the same, it indicates that the to-be-stored sub-data block is the same as the reference sub-data block, or if the fingerprints are different, it indicates that the to-be-stored sub-data block is different from the reference sub-data block.

Fingerprints of sub-data blocks are compared, thereby avoiding comparison performed on a bit basis when the sub-data blocks are compared. Therefore, comparison operation complexity is reduced.

In one embodiment, the selection unit is configured to select, from the at least two comparison data blocks as the reference data block, a comparison data block that has a largest quantity of sub-data blocks the same as those in the to-be-stored data block.

The to-be-stored data block is compared with multiple comparison data blocks, so that a similarity between each comparison data block and the to-be-stored data block can be determined. A comparison data block that has a largest quantity of sub-data blocks the same as those in the to-be-stored data block is a data block that has a highest similarity with the to-be-stored data block. Further, a comparison data block that has a smallest quantity of clusters of different sub-data blocks is selected as the reference data block from comparison data blocks that have a highest similarity with the to-be-stored data block, so that information required for recording locations of different sub-data blocks can be reduced, and a deduplication operation compression ratio is further increased.

In one embodiment, the selection unit is configured to select a reference sub-data block that is corresponding to a location identifier that is corresponding to each first sub-data block as the representative sub-data block of the first sub-data block. Further, the selection unit may be configured to select a comparison data block that has a largest quantity of sub-data blocks the same as those in the to-be-stored data block and that has a smallest quantity of clusters of different sub-data blocks as the reference data block. A cluster of different sub-data blocks is a set of different sub-data blocks that are continuous in locations, and sub-data blocks at adjacent locations of the set are same sub-data blocks.

Data blocks stored in a database have a higher similarity with each other, and a same part of different data blocks generally has a same relative location in the data blocks. Therefore, the reference sub-data block that is corresponding to the location identifier that is corresponding to each first sub-data block is selected as the representative sub-data block of the first sub-data block, so that a large quantity of continuous “0s” can appear in an XOR result, and a run-length encoding compression ratio is greatly reduced.

In one embodiment, the selection unit is configured to: separately perform an XOR operation on the first sub-data block and at least two stored sub-data blocks by using an XOR unit, and select a stored sub-data block as the representative sub-data block according to run-length encoding compression ratios of results of the XOR operations, where a result of XOR operations performed on the stored sub-data block and the first sub-data block has a smallest run-length encoding compression ratio.

The stored sub-data block is selected as the representative sub-data block from stored sub-data blocks by means of comparison, where a result of an XOR operation performed on the first sub-data block and the stored sub-data block has the smallest run-length encoding compression ratio, so that storage space required for storing the to-be-stored data block can be reduced to a relatively large extent.

In one embodiment, the selection unit is configured to: perform an XOR operation on every two first sub-data blocks by using an XOR unit, and select a first sub-data block as the representative sub-data block according to run-length encoding compression ratios of results of the XOR operations, where a result of XOR operations performed on the first sub-data block and another first sub-data block has a smallest run-length encoding compression ratio.

The first sub-data blocks are searched for the first sub-data block that has a highest similarity with the another first sub-data block, and the first sub-data block is used as the representative sub-data block, so that storage space required for storing the to-be-stored data block can be reduced without depending on stored sub-data blocks.

In one embodiment, the selection unit is further configured to: extract a sample from to-be-stored data, separately determine a storage compression ratio, a storage speed, and a read speed of the sample according to different to-be-stored sub-data block sizes, and determine a value of N according to a size of a sub-data block with a smallest storage compression ratio if the storage speed and the read speed meet a constraint condition, where the constraint condition is that the storage speed is greater than or equal to a first preset threshold, and the read speed is greater than or equal to a second preset threshold.

A most proper data block division method is selected by extracting the sample, so that storage space required for storing the to-be-stored data block can be reduced to a greatest extent when the storage processing speed and the read processing speed are met.

In one embodiment, the comparison unit is further configured to store a fingerprint of the first sub-data block. Therefore, when the first sub-data block is subsequently used as a reference sub-data block of another data block, there is no need to repeatedly calculate the fingerprint.

According to the technical solutions disclosed in the present application, according to features of data similarity and location correlation in a database, a data block to be stored is divided into sub-data blocks of a smaller granularity, sub-data blocks that are of the to-be-stored data block and a reference data block and that are at a same location are compared, a deduplication operation is performed on same sub-data blocks with a relatively small calculation amount, an XOR operation is performed on a sub-data block and a reference sub-data block that are different from each other, and run-length encoding compression is performed on an XOR result. Therefore, storage space required for recording the to-be-stored data block is greatly reduced.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and persons of ordinary skill in the art may still derive other drawings from these accompanying drawings without creative efforts.

FIG. 1 is a block diagram of an example of a networking environment of a data storage system;

FIG. 2 is a schematic diagram of a hardware structure of a computing device according to an embodiment of the present application;

FIG. 3 is an example flowchart of a data storage method according to an embodiment of the present application;

FIG. 4 is a schematic diagram of a data block division method according to an embodiment of the present application;

FIG. 5 is a schematic diagram showing comparison between comparison data blocks according to an embodiment of the present application; and

FIG. 6 is a schematic diagram of a logical structure of a data storage apparatus according to an embodiment of the present application.

### DESCRIPTION OF EMBODIMENTS

The following describes the technical solutions in the embodiments of the present application with reference to the accompanying drawings in the embodiments of the present application.

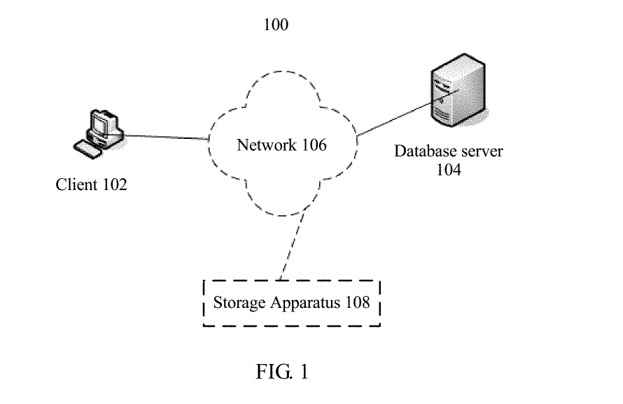

According to this application, a storage device of a database server stores data information to be used by a client, and data to be stored on the storage device of the database server may be or may not be deduplicated and compressed. However, storage space that is required by the to-be-stored data for being on the storage device of the database server can be greatly reduced by means of deduplication and compression, and storage resources can be saved. FIG. 1 is a block diagram of an example of a networking environment of a data storage system 100. The data storage system 100 includes a client 102 and a database server 104, and may further include a storage apparatus 108. It should be understood that the foregoing names are merely for ease of description, and shall not constitute any limitation on the present application.

A storage device of the database server 104 stores data to be used by the client 102, to provide services for an application of the client 102. These services may be storage, query, update, transaction management, index, cache, query optimization, security control, multi-user access control, and the like. The database server 104 may include one or more computers and database management system software.

A communications interface used for mutual communication is configured for each of the database server 104 and the client 102. Optionally, the database server 104 communicates with the client 102 by using a network 106.

The network 106 may be the Internet, an intranet, a local area network (LAN), a wide area network (WAN), a storage area network (SAN), or the like, or a combination of the foregoing networks.

The storage apparatus 108 may be coupled to the database server 104 and/or the client 102 by using the communications interface, or may be coupled to the database server 104 and/or the client 102 by using the network 106. Either or both of the database server 104 and the client 102 may access the storage apparatus 108. Optionally, the storage apparatus 108 may serve as a storage device of the database server 104 to store data deduplicated and compressed by the database server 104.

It should be understood that FIG. 1 is merely intended to introduce an example of participants of the data storage system 100 and a correlation between the participants. Therefore, the described system 100 is greatly simplified. In this embodiment of the present application, the system 100 is merely described in general, and an implementation of the system 100 is not limited. In addition, the client 102 and the database server 104 in FIG. 1 may be of any architecture. This is not limited in this embodiment of the present application.

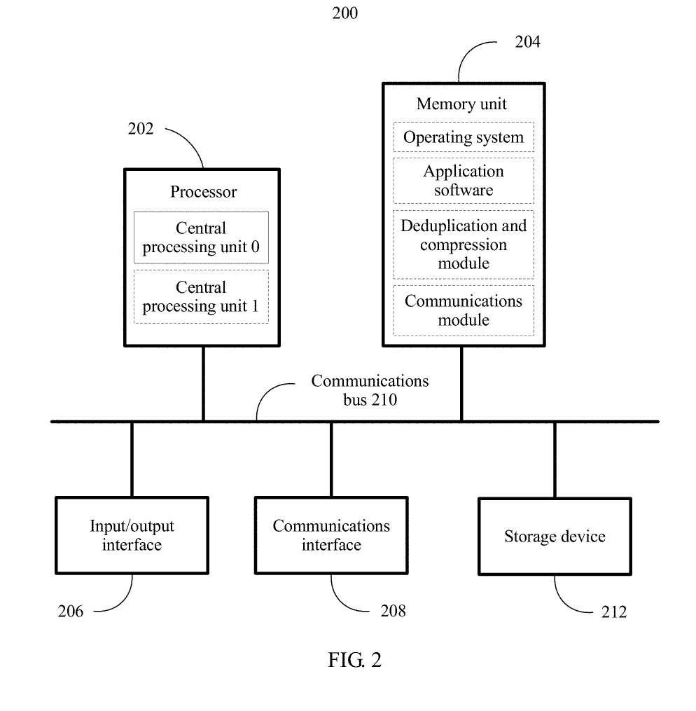

The client 102 and/or the database server 104 shown in FIG. 1 may be implemented by a computing device 200 shown in FIG. 2.

FIG. 2 is a schematic diagram of a simplified logical structure of the computing device 200. As shown in FIG. 2, the computing device 200 includes a processor 202, a memory unit 204, an input/output interface 206, a communications interface 208, a bus 210, and a storage device 212. The processor 202, the memory unit 204, the input/output interface 206, the communications interface 208, and the storage device 212 implement mutual communication connection by using the bus 210.

The processor 202 is a control center of the computing device 200, and is configured to execute a related program to implement a technical solution provided in this embodiment of the present application. Optionally, the processor 202 includes one or more central processing units (CPU), for example, a central processing unit 0 and a central processing unit 1 shown in FIG. 2. Optionally, the computing device 200 may include multiple processors 202. Each processor 202 may be a single-core processor (including one CPU) or a multi-core processor (including multiple CPUs). Unless otherwise stated, in the present application, a component configured to execute a specific function, for example, the processor 202 or the memory unit 204, may be implemented by configuring a general-purpose component to execute the corresponding function, or may be implemented by a dedicated component that specially executes the specific function. This is not limited in this application. The processor 202 may be a general-purpose central processing unit, a microprocessor, an application-specific integrated circuit (ASIC), or one or more integrated circuits configured to execute a related program to implement the technical solutions provided in this application.

The processor 202 may be connected to one or more storage mediums by using the bus 210. The storage solutions may include the memory unit 204 and the storage device 212. The storage device 212 may be a read only memory (ROM), a static storage device, a dynamic storage device, or a random access memory (RAM). The memory unit 204 may be a random access memory. The memory unit 204 may be integrated with the processor 202 or integrated into the processor 202, or may be one or more storage units independent of the processor 202.

Program code to be executed by the processor 202 or a CPU in the processor 202 may be stored in the storage device 212 or the memory unit 204. Optionally, program code (for example, an operating system, an application program, a deduplication and compression module, or a communications module) stored in the storage device 212 is copied into the memory unit 204 for being executed by the processor 202.

The storage device 212 may include a high-speed random access memory (RAM), or may include nonvolatile memory, for example, one or more magnetic disk memories, a flash memory, or another nonvolatile memory. In some embodiments, the storage device may further include a remote memory that is separated from the one or more processors 202, for example, a network disk that is accessed by using the communications interface 208 and a communications network. The communications network may be the Internet, an intranet, a local area network (LAN), a wide area network (WAN), a storage area network (SAN), or the like, or a combination of the foregoing networks. The storage device 212 may be further configured to store data deduplicated and compressed by a database server 104.

The operating system (for example, Darwin, RTXC, LINUX, UNIX, OS X, WINDOWS, or an embedded operating system such as Vxworks) includes various software components and/or drivers that are used for controlling and managing regular system tasks (for example, memory management, storage device control, and power management) and that facilitate communication between various hardware and software components.

The input/output interface 206 is configured to receive input data and information, and output data such as an operation result.

The communications interface 208 is, for example, but is not limited to a transceiver apparatus such as a transceiver, to implement communication between the computing device 200 and another device or a communications network.

The bus 210 may include a channel, to transfer information between parts (for example, the processor 202, the memory unit 204, the input/output interface 206, the communications interface 208, and the storage device 212) of the computing device 200. Optionally, the bus 210 may use a wired connection manner or use a wireless communication manner. This is not limited in this application.

It should be noted that, although for the computing device 200 shown in FIG. 2, only the processor 202, the memory unit 204, the input/output interface 206, the communications interface 208, the bus 210, and the storage device 212 are shown, in a specific implementation process, persons skilled in the art should understand that the computing device 200 further includes another device required for implementing normal running.

The computing device 200 may be a general-purpose computer or a computing device with a dedicated function, and includes but is not limited to any electronic device such as a portable computer, a personal desktop computer, a network server, a tablet computer, a mobile phone, or a personal digital assistant (PDA), or a device integrating two or more of the foregoing devices. A specific implementation form of the computing device 200 is not limited in this application.

In addition, the computing device 200 in FIG. 2 is merely an example of a computing device 200. The computing device 200 may include more or fewer components than those shown in FIG. 2, or have different component configuration manners. Persons skilled in the art should understand that, according to a specific requirement, the computing device 200 may further include a hardware device that implements another additional function. Alternatively, persons skilled in the art should understand that the computing device 200 may include only a device required for implementing this embodiment of the present application, and does not necessarily include all devices shown in FIG. 2. In addition, various components shown in FIG. 2 may be implemented by using hardware, software, or a combination of hardware and software.

The hardware structure shown in FIG. 2 and the foregoing descriptions are applicable to various computing devices provided in the embodiments of the present application, and are applicable to executing various data storage methods provided in the embodiments of the present application.

As shown in FIG. 2, the memory unit 204 of the computing device 200 includes a deduplication and compression module. The processor 202 executes program code of the deduplication and compression module, to perform a deduplication and compression operation on data to be stored in the storage device 212 of the database server 104. During data storage, the database server 104 stores to-be-stored data on a data block basis. There is a relatively high similarity between different data blocks, and parts that are with same data and that are in the different data blocks have a same relative location in the data blocks. According to this feature, when a deduplication operation is performed on similar data, data that is in a to-be-stored data block and a reference data block and that is at a same relative location may be compared, so that cross-comparison of data at different relative locations is avoided, and comparison complexity is greatly reduced.

The deduplication and compression module may include one or more operation instructions, so that the computing device performs one or more method operations according to the foregoing descriptions. A specific method operation is described in detail in the following parts of this application.

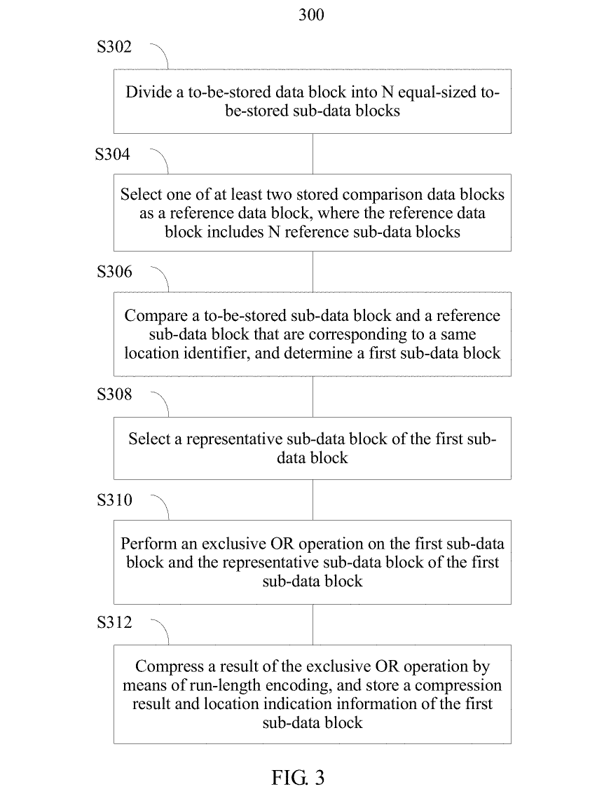

FIG. 3 is an example flowchart of a data storage method 300 according to an embodiment of the present application. As shown in FIG. 3, the method 300 includes the following operations.

In operation S302, a to-be-stored data block is divided into N equal-sized to-be-stored sub-data blocks.

The N to-be-stored sub-data blocks are corresponding to N location identifiers, each to-be-stored sub-data block is corresponding to one location identifier, and N is a positive integer greater than 1. Specifically, the to-be-stored data block is divided into the N to-be-stored sub-data blocks, and a location ranking of a to-be-stored sub-data block in the to-be-stored data block may be used to represent a location identifier of the to-be-stored sub-data block.

In a specific implementation process, a size of the to-be-stored data block may be a size of a basic storage unit stored in a database, and the basic storage unit in the database is further divided into smaller sub-data blocks. For example, a data block in the basic storage unit is of 8 Kbytes, and if an optimal size of a to-be-stored sub-data block is 256 bytes, the to-be-stored data block is divided into 32 to-be-stored sub-data blocks whose sizes are 256 bytes. The to-be-stored data block whose size is 8 Kbytes is divided into smaller to-be-stored sub-data blocks, and a size of each to-be-stored sub-data block is 256 bytes. In this way, a basic unit for performing comparison during similar deduplication becomes 256 bytes.

In operation S304, one of at least two stored comparison data blocks is selected as a reference data block.

The reference data block includes N reference sub-data blocks, the N reference sub-data blocks are corresponding to the N location identifiers, and each reference sub-data block is corresponding to one location identifier. A manner for dividing the reference data block is the same as a manner for dividing the to-be-stored data block, and a manner for indicating the location identifier is the same as that of the to-be-stored data block.

In operation S306, a to-be-stored sub-data block and a reference sub-data block that are corresponding to a same location identifier are compared, and a first sub-data block is determined, where the first sub-data block is a to-be-stored sub-data block different from a compared reference sub-data block.

Specifically, a to-be-stored sub-data block corresponding to an i^{th} location identifier and a reference sub-data block corresponding to the i^{th} location identifier are compared, and the first sub-data block is determined in the N to-be-stored sub-data blocks, where i is a positive integer progressively increasing from 1 to N. A quantity of first sub-data blocks may be 1 or a positive integer greater than 1.

In operation S308, a representative sub-data block of the first sub-data block is selected.

In operation S310, an XOR operation is performed on the first sub-data block and the representative sub-data block of the first sub-data block.

In operation S312, a result of the XOR operation in operation S310 is compressed using run-length encoding, and a compression result and location information of the first sub-data block are stored.

In operation S306, when the to-be-stored sub-data block and the reference sub-data block that are corresponding to the same location identifier are compared, to avoid comparison performed on a byte basis, a fingerprint of the to-be-stored sub-data block and a fingerprint of the reference sub-data block may be compared. If the fingerprints are the same, it indicates that the two sub-data blocks are the same. If the fingerprints are different, it indicates that the two sub-data blocks are different. A fingerprint is an identity certificate of a sub-data block. The fingerprint of the sub-data block is calculated by using multiple methods. For example, a hash fingerprint of a sub-data block may be calculated by using a method such as calculating an SHA1 or MD5 hash value. This is not limited in this embodiment of the present application.

The fingerprints of the to-be-stored sub-data block and the reference sub-data block that are corresponding to the same location identifier are compared, the first sub-data block is determined, and the location information of the first sub-data block is stored.

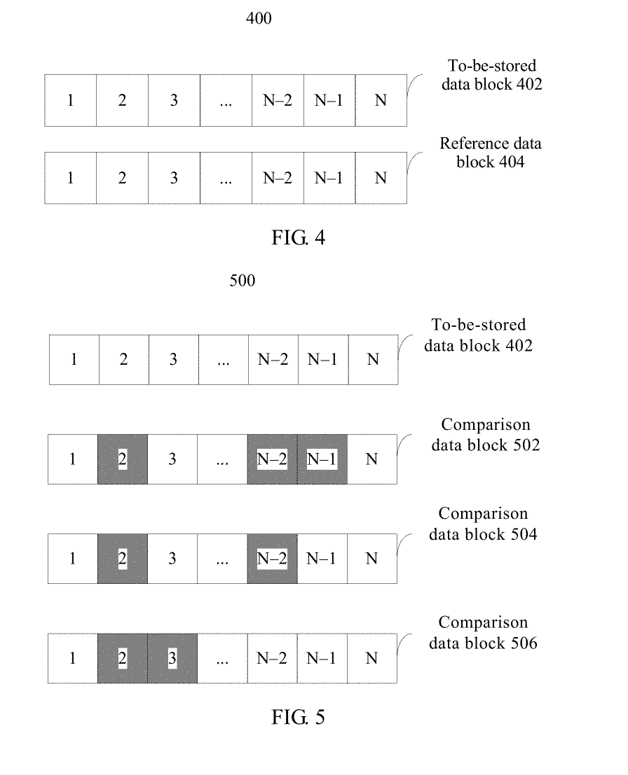

A possible division and comparison manner for the to-be-stored data block and the reference data block is shown in FIG. 4. A to-be-stored data block 402 is divided, according to a data sequence, into N equal-sized to-be-stored sub-data blocks numbered from 1 to N, and a ranking of a to-be-stored sub-data block may be used to represent a location identifier of the to-be-stored sub-data block. For example, i represents a location identifier of an i^{th} to-be-stored sub-data block. Likewise, a reference data block 404 is also divided into N equal-sized sub-data blocks numbered from 1 to N. Fingerprints of sub-data blocks with a same location identifier in the to-be-stored data block 402 and the reference data block 404 are compared, and fingerprints of a to-be-stored sub-data block and a reference sub-data block that are corresponding to a same location identifier are separately compared according to a location sequence. If the fingerprints are the same, it indicates that the sub-data blocks are the same. If the fingerprints are different, it indicates that the sub-data blocks are different. That is, a fingerprint of the to-be-stored sub-data block corresponding to the i^{th} location identifier and a fingerprint of the reference sub-data block corresponding to the i^{th} location identifier are compared. If the fingerprints are the same, it indicates that the to-be-stored sub-data block is the same as the reference sub-data block. If the fingerprints are different, it indicates that the to-be-stored sub-data block is different from the reference sub-data block, where i progressively increases from 1 to N.

If the fingerprints are the same, a deduplication operation may be performed on the to-be-stored sub-data block with the i^{th} location identifier, that is, the i^{th} to-be-stored sub-data block is not stored, and during data read, the i^{th} to-be-stored sub-data block of the to-be-stored data block 402 is restored by using the i^{th} reference sub-data block of the reference data block 404. If the fingerprints are different, it indicates that the i^{th} sub-data block of the to-be-stored data block 402 is different from the i^{th} sub-data block of the reference data block 404. In this case, location information of the i^{th} to-be-stored sub-data block is stored, operations in subsequent operations S308 to S312 are performed on the i^{th} sub-data block of the to-be-stored data block 402, and information after the operations is stored, where i progressively increases from 1 to N.

Optionally, in an implementation of this embodiment of the present application, the to-be-stored data block and the reference data block may be compared by using a “dichotomy”, to find location information of sub-data blocks that are of the to-be-stored data block and the reference data block, that have a same location identifier, and that have different fingerprints.

A specific implementation procedure includes: the to-be-stored data block and the reference data block are separately divided into two equal-sized data blocks: a “left data block” and a “right data block”, and a fingerprint of a “left data block” and a fingerprint of a “right data block” of the to-be-stored data block are calculated. The fingerprint of the “left data block” of the to-be-stored data block and a fingerprint of a “left data block” of the reference data block are compared, and the fingerprint of the “right data block” of the to-be-stored data block and a fingerprint of a “right data block” of the reference data block are compared (if the fingerprint of the “left data block” and the fingerprint of the “right data block” of the reference data block are stored, values of the stored fingerprints may be directly used, or if the fingerprint of the “left data block” and the fingerprint of the “right data block” of the reference data block are not stored, the fingerprint of the “left data block” and the fingerprint of the “right data block” of the reference data block are calculated). If the fingerprint of the “left (right) data block” of the to-be-stored data block is the same as the fingerprint of the “left (right) data block” of the reference data block, it indicates that the “left (right) data block” of the to-be-stored data block is the same as the “left (right) data block” of the reference data block, and the “left (right) data block” of the to-be-stored data block and the “left (right) data block” of the reference data block are not further divided. If the fingerprint of the “left (right) data block” of the to-be-stored data block is different from the fingerprint of the “left (right) data block” of the reference data block, it indicates that the “left (right) data block” of the to-be-stored data block is different from the “left (right) data block” of the reference data block, and the “left (right) data block” of the to-be-stored data block and the “left (right) data block” of the reference data block are divided according to a same principle by using a “dichotomy”, and fingerprints of data blocks obtained by means of division are separately compared. Division and comparison are performed in this manner, until a size of a data block obtained by means of division is equal to a size of a sub-data block. Therefore, location information of all sub-data blocks that are of the to-be-stored data block and the reference data block, that are at same locations, and that have different fingerprints is found, and the location information of the sub-data blocks that have different fingerprints is recorded.

When there is a relatively high similarity between the to-be-stored data block and the reference data block, use of the dichotomy can reduce a calculation amount of finding location information of sub-data blocks that are of the to-be-stored data block and the reference data block, that are at a same location, and that have different fingerprints, and improve a deduplication and compression speed.

It should be understood that the location information of the first sub-data block may be stored in multiple manners. For example, the location information of the first sub-data block may be stored by recording the location information of the first sub-data block, and a to-be-stored sub-data block whose location information is not recorded is a second sub-data block. Alternatively, the location information of the first sub-data block may be stored by recording location information of a second sub-data block, and a to-be-stored sub-data block whose location information is not recorded is the first sub-data block. In this embodiment of the present application, a manner for storing the location information of the first sub-data block is not limited.

In a specific implementation process, a ranking of the first sub-data block in the to-be-stored data block may be used to represent the location information of the first sub-data block. For example, as shown in FIG. 4, the location information of the i^{th} to-be-stored sub-data block in the to-be-stored data block may be represented by using i, where i is a positive integer greater than 0 and less than or equal to N. When the location information of the first sub-data block is recorded, this may be implemented by recording the location ranking of the first sub-data block in the to-be-stored data block, and a to-be-stored sub-data block whose location ranking is not recorded is a second sub-data block, or this may be implemented by recording a location ranking of a second sub-data block, and a to-be-stored sub-data block whose location ranking is not recorded is the first sub-data block.

In a specific implementation process, alternatively, the location information of the first sub-data block may be recorded by recording a head address and a tail address of the first sub-data block or by recording a head address and an address length of the first sub-data block. If location information of multiple first sub-data blocks is continuous, the continuous location information is recorded by recording only head addresses and tail addresses of continuous locations or by recording only head addresses and address lengths of continuous locations, so as to reduce storage space required for recording the continuous location information. It should be understood that the head address of the first sub-data block herein may be offset relative to a head address of the to-be-stored data block.

There is a higher similarity between data blocks stored in a database server 104, and a same part of different data blocks generally has a same relative location in the data blocks. According to this feature that a same part of different data blocks generally has a same location, a to-be-stored data block is divided into to-be-stored sub-data blocks of a smaller granularity, and fingerprints of sub-data blocks that are of the to-be-stored data block and a reference data block and that have a same location identifier are compared, thereby avoiding cross-comparison of sub-data blocks with different location identifiers, so that a same part of the to-be-stored data block and the reference data block can be found with a relatively small calculation amount, and a deduplication operation is performed on the same part, that is, sub-data blocks that are of the to-be-stored data block and the reference data block, that are at a same location, and that have a same fingerprint are not stored. During data restoration, the deduplicated sub-data block may be restored according to a sub-data block at a corresponding location of the reference data block. Therefore, a storage unit required for recording the to-be-stored data block is greatly reduced.

A fingerprint of a reference sub-data block of the reference data block may be calculated when the reference data block is stored, and is stored in a database. Alternatively, fingerprint calculation may be performed when the reference sub-data block and the to-be-stored sub-data block that are corresponding to the same location identifier and that are of the reference data block and the to-be-stored data block are compared. This is not limited in this embodiment of the present application.

Specifically, in operation S304, the selecting one of at least two stored comparison data blocks as a reference data block specifically includes: comparing the to-be-stored data block and the at least two comparison data blocks, where comparison is performed in a manner in operation 306; and selecting, from the at least two comparison data blocks as the reference data block, a comparison data block that has a largest quantity of sub-data blocks the same as those in the to-be-stored data block. Further, a comparison data block that has a largest quantity of sub-data blocks the same as those in the to-be-stored data block and that has a smallest quantity of clusters of different sub-data blocks may be selected as the reference data block. A cluster of different sub-data blocks is a set of different sub-data blocks that are continuous in locations, and sub-data blocks at adjacent locations of the set are same sub-data blocks.

The to-be-stored data block is compared with multiple comparison data blocks, so that a similarity between each comparison data block and the to-be-stored data block can be determined. A comparison data block that has a largest quantity of sub-data blocks the same as those in the to-be-stored data block is a data block that has a highest similarity with the to-be-stored data block. Further, a comparison data block that has a smallest quantity of clusters of different sub-data blocks is selected as the reference data block from comparison data blocks that have a highest similarity with the to-be-stored data block, so that information required for recording locations of different sub-data blocks can be reduced, and a deduplication operation compression ratio is further increased.

For example, as shown in FIG. 5, the to-be-stored data block 402 is compared with a comparison data block 502, a comparison data block 504, and a comparison data block 506, and fingerprints of sub-data blocks at a same location of the to-be-stored data block 402 and each comparison data block are compared. If the fingerprints are the same, it indicates that the sub-data blocks are the same sub-data blocks. If the fingerprints are different, it indicates that the sub-data blocks are different sub-data blocks. As shown in FIG. 5, when the comparison data block 502 is compared with the to-be-stored data block 402, there are three different sub-data blocks: a second sub-data block, a (N−2)^{th} sub-data block, and a (N−1)^{th} sub-data block. When the comparison data block 504 is compared with the to-be-stored data block 402, there are two different sub-data blocks: the second sub-data block and the (N−2)^{th} sub-data block. When the comparison data block 506 is compared with the to-be-stored data block 402, there are two different sub-data blocks: the second sub-data block and the third sub-data block. It is found by means of comparison that each of the comparison data block 504 and the comparison data block 506 has a largest quantity of sub-data blocks the same as those in the to-be-stored data block 402, that is, N−2 sub-data blocks. The comparison data block 506 has one cluster of different sub-data blocks, that is, a set including the second sub-data block and the third sub-data block, and the comparison data block 504 has two clusters of different sub-data blocks, that is, the second sub-data block and the (N−2)^{th} sub-data block. Therefore, the comparison data block 506 with a smallest quantity of clusters of different sub-data blocks is selected as a reference data block.

Fingerprints of sub-data blocks that are at a same location of the to-be-stored data block 402 and the comparison data block 506 are compared, and if it is found that fingerprints of the second sub-data block and the third sub-data block of the to-be-stored data block 402 are different from fingerprints of the second sub-data block and the third sub-data block of the comparison data block 506, location information of the second sub-data block and the third sub-data block is recorded. For example, an initial location and an end location of the cluster including the second sub-data block and the third sub-data block may be recorded, or an initial location of the cluster and a data length of the cluster may be recorded. This is not limited in this embodiment of the present application.

Optionally, in operation S308, the selecting a representative sub-data block of the first sub-data block includes: selecting a reference sub-data block that is corresponding to a location identifier that is corresponding to each first sub-data block as the representative sub-data block of the first sub-data block.

For example, as shown in FIG. 5, a reference data block of the to-be-stored data block 402 is the comparison data block 506. As shown in FIG. 5, when the comparison data block 506 is compared with the to-be-stored data block 402, there are two different sub-data blocks: the second sub-data block and the third sub-data block. Therefore, the second sub-data block of the comparison data block 506 is selected as a representative data block of the second to-be-stored sub-data block of the to-be-stored data block 402, and the third sub-data block of the comparison data block 506 is selected as a representative data block of the third to-be-stored sub-data block of the to-be-stored data block 402. An XOR operation is performed on the second sub-data block of the to-be-stored data block 402 and the second sub-data block of the comparison data block 506, and an XOR operation is performed on the third sub-data block of the to-be-stored data block 402 and the third sub-data block of the comparison data block 506. Because the second to-be-stored sub-data block and the third to-be-stored sub-data block are continuous in locations, run-length encoding may be uniformly performed on XOR results of the second to-be-stored sub-data block and the third to-be-stored sub-data block, and location information is uniformly recorded.

Optionally, in operation S308, the selecting a representative sub-data block of the first sub-data block includes: separately performing an XOR operation on the first sub-data block and at least two stored sub-data blocks, and selecting a stored sub-data block as the representative sub-data block according to run-length encoding compression ratios of results of the XOR operations, where a result of XOR operations performed on the stored sub-data block and the first sub-data block has a smallest run-length encoding compression ratio.

That is, an XOR operation is separately performed on multiple optional stored sub-data blocks and all first sub-data blocks, run-length encoding compression ratios of results of the XOR operations are separately calculated, and a stored sub-data block corresponding to a smallest run-length encoding compression ratio is selected as the reference sub-data block.

Optionally, in operation S308, the selecting a representative sub-data block of the first sub-data block includes: performing an XOR operation on every two first sub-data blocks, and selecting a first sub-data block as the representative sub-data block according to run-length encoding compression ratios of results of the XOR operations, where a result of XOR operations performed on the first sub-data block and another first sub-data block has a smallest run-length encoding compression ratio; and storing the representative sub-data block.

For example, the to-be-stored data block has M first sub-data blocks. For ease of description, the M first sub-data blocks are numbered from 1 to M according to a location sequence in the to-be-stored data block, and an XOR operation is separately performed on every two of the M first sub-data blocks. In addition, run-length encoding compression ratios of XOR results between each first sub-data block and other M−1 first sub-data blocks are calculated, that is, run-length encoding compression ratios of XOR results between the first first sub-data block and the second to the M^{th} first sub-data blocks are calculated, and run-length encoding compression ratios of XOR results between the second first sub-data block and the other M−1 first sub-data blocks (the first first sub-data block and the third to the M^{th} first sub-data blocks) are calculated. In this manner, run-length encoding compression ratios of XOR results between the M^{th} first sub-data block and the first M−1 first sub-data blocks are calculated, and a first sub-data block is selected as the representative sub-data block, where results of XOR operations performed on the first sub-data block and the other M−1 first sub-data blocks have a smallest run-length encoding compression ratio.

Specifically, in run-length encoding, compression encoding is performed by recording a character that continuously appears and a quantity of times that the character continuously appears. Therefore, during specific implementation, a run-length encoding compression ratio of a result of XOR operations performed on each first sub-data block and another first sub-data block may be determined by calculating a size of compression space generated by performing run-length encoding on a character that continuously appears in the XOR result. Larger compression space generated by performing run-length encoding indicates a larger run-length encoding compression ratio. For example, three same characters continuously appear, that is, 24 “0s” continuously appear, and storage space required for recording information that three same characters continuously appear is subtracted from three bytes, to obtain a size of generated compression space. If the storage space required for recording the information that three same characters continuously appear is two bytes, the generated compression space is one byte.

In S310, the XOR operation is performed on the first sub-data block and the representative sub-data block of the first sub-data block. The XOR operation is performed for a binary bit of a sub-data block, that is, an XOR operation is performed on the to-be-stored sub-data block and the reference sub-data block. If values of bits at a same location of the to-be-stored sub-data block and the reference sub-data block are the same, an XOR result is 0. If values of bits at a same location of the to-be-stored sub-data block and the reference sub-data block are different, an XOR result is 1.

The XOR result is a binary string including “0” and/or “1”. Therefore, storage space required for recording information is reduced by compressing the XOR result using run-length encoding.

The method 300 further includes: storing a fingerprint of the first sub-data block. Therefore, when the first sub-data block is subsequently used as a reference sub-data block of another data block, there is no need to repeatedly calculate the fingerprint.

During data read, an XOR result may be restored according to a stored run-length encoding result, different sub-data blocks may be restored according to the restored XOR result and the stored representative sub-data block. At a location at which the XOR result is “1”, it indicates that a value of the first sub-data block at the location is opposite to a value of the representative sub-data block, and at a location at which the XOR result is “0”, it indicates that a value of the first sub-data block at the location is the same as a value of the representative sub-data block. The original to-be-stored data block may be restored according to the restored first sub-data block, the stored location information of the first sub-data block, and the stored reference data block.

In an implementation of this embodiment of the present application, before operation 302, the method 300 further includes: extracting a sample from to-be-stored data, separately determining a storage compression ratio, a storage speed, and a read speed of the sample according to different to-be-stored sub-data block sizes, and determining a value of N according to a size of a sub-data block with a smallest storage compression ratio if the storage speed and the read speed meet a constraint condition, where the constraint condition is that the storage speed is greater than or equal to a preset first threshold, and the read speed is greater than or equal to a preset second threshold.

In a specific process, in a process of determining quantity N for sub-data blocks, a proper sub-data block size and the quantity N of sub-data blocks may be determined according to sample data. It is assumed that a size of the to-be-stored data block is K, and a size of the to-be-stored sub-data block is M. A value of M needs to meet the following constraints:

M>0, that is, the value of M needs to be a positive number;

K/M>2, that is, a quantity of to-be-stored sub-data blocks should be greater than or equal to 2; and

KmodM=0, that is, a result obtained after K modulo M is 0, to ensure that sizes of to-be-stored sub-data blocks are the same.

In values of M that meet the foregoing conditions, according to the procedure of the method 300, for the different to-be-stored sub-data block sizes M, the storage compression ratio, the storage speed, and the read speed of the sample are calculated. When the following constraint condition is satisfied: the storage speed is greater than or equal to the preset first threshold, and the read speed is greater than or equal to the preset second threshold, a value of M with a smallest storage compression ratio is selected from the values of M, and the quantity N of sub-data blocks is determined according to N=K/M. The storage compression ratio is a ratio of a size of deduplicated and compressed data to the size of the to-be-stored data block. The deduplicated and compressed data is data required for storing information about the to-be-stored data block, and includes a run-length encoding result, data required for recording information about the reference data block and the reference sub-data block, and data for recording the location information of the first sub-data block.

It should be understood that the process of determining the size of the sub-data block and the quantity N of sub-data blocks is described above only as an example. The size of the sub-data block and the quantity N of sub-data blocks may be determined according to a statistical result of the sample data, or may be determined in another manner. For example, the size of the sub-data block and the quantity N dynamically change based on an empirical value, or are set before a system runs. This is not limited in this embodiment of the present application.

It should be understood that the method 300 may be executed by a client 102, or executed by the database server 104, or some operations are performed by a client 102, and some operations are performed by the database server 104. For example, the client may divide the to-be-stored data block into the N to-be-stored sub-data blocks, calculate a fingerprint of each to-be-stored sub-data block, and then send the fingerprints of the N to-be-stored sub-data blocks to the server 104. The server 104 performs operation S304, selects a reference data block for the to-be-stored data block, determines the first sub-data block by comparing the to-be-stored sub-data block and the reference sub-data block that are with the same location identifier, and sends indication information of the first sub-data block to the client 102, the client 102 then sends the first sub-data block to the database server 104, and the database server performs subsequent operations. A specific execution body of the method 300 is not limited in this embodiment of the present application.

According to the technical solution disclosed in this embodiment of the present application, according to features of data similarity and location correlation in a database, a to-be-stored data block is divided into sub-data blocks of a smaller granularity, sub-data blocks that are of the to-be-stored data block and a reference data block and that are at a same location are compared, a deduplication operation is performed on same sub-data blocks with a relatively small calculation amount, an XOR operation is performed on a sub-data block and a reference sub-data block that are different from each other, and run-length encoding compression is performed on an XOR result. Therefore, storage space required for recording the to-be-stored data block is greatly reduced.

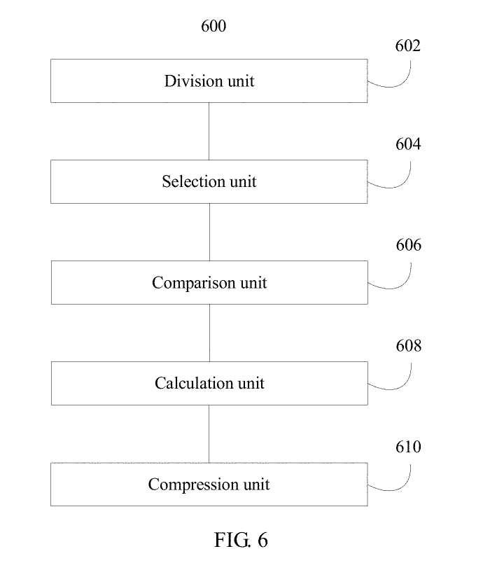

FIG. 6 is a schematic diagram of a logical structure of a data storage apparatus 600 according to an embodiment of the present application. As shown in FIG. 6, the apparatus 600 includes a division unit 602, a selection unit 604, a comparison unit 606, a calculation unit 608, and a compression unit 610.

The division unit 602 is configured to divide a to-be-stored data block into N equal-sized to-be-stored sub-data blocks. The N to-be-stored sub-data blocks are corresponding to N location identifiers, each to-be-stored sub-data block is corresponding to one location identifier, and N is a positive integer greater than 1.

The selection unit 604 is configured to select one of at least two stored comparison data blocks as a reference data block. The reference data block includes N reference sub-data blocks, the N reference sub-data blocks are corresponding to the N location identifiers, and each reference sub-data block is corresponding to one location identifier.

The comparison unit 606 is configured to: compare a to-be-stored sub-data block corresponding to an i^{th} location identifier and a reference sub-data block corresponding to the i^{th} location identifier, and determine a first sub-data block in the N to-be-stored sub-data blocks, where i is a positive integer progressively increasing from 1 to N, and the first sub-data block is a to-be-stored sub-data block different from a compared reference sub-data block.

The selection unit 604 is further configured to select a representative sub-data block of the first sub-data block.

The calculation unit 608 is configured to perform an XOR operation on data of the first sub-data block and data of the representative sub-data block.

The compression unit 610 is configured to: compress a result of the XOR operation using run-length encoding, and store a compression result and location information of the first sub-data block.

In a specific implementation process, the apparatus 600 further includes a deduplication unit. The comparison unit 606 is further configured to determine a second sub-data block in the N to-be-stored sub-data blocks. The second sub-data block is a to-be-stored sub-data block the same as a compared reference sub-data block. The deduplication unit is configured to perform a deduplication operation on the second sub-data block.

According to features of data similarity and location correlation in a database, a to-be-stored data block is divided into sub-data blocks of a smaller granularity, sub-data blocks that are of the to-be-stored data block and a reference data block and that are at a same location are compared, a deduplication operation is performed on same sub-data blocks with a relatively small calculation amount, an XOR operation is performed on a sub-data block and a reference sub-data block that are different from each other, and run-length encoding compression is performed on an XOR result. Therefore, storage space required for recording the to-be-stored data block is greatly reduced.

When a to-be-stored sub-data block and a reference sub-data block that are corresponding to a same location identifier are compared, to avoid comparison performed on a byte basis, the comparison unit 606 is specifically configured to compare a fingerprint of the to-be-stored sub-data block corresponding to the i^{th} location identifier and a fingerprint of the reference sub-data block corresponding to the i^{th} location identifier. If the fingerprints are the same, it indicates that the to-be-stored sub-data block is the same as the reference sub-data block, or if the fingerprints are different, it indicates that the to-be-stored sub-data block is different from the reference sub-data block. Fingerprints of sub-data blocks are compared, thereby avoiding comparison performed on a bit basis when the sub-data blocks are compared. Therefore, comparison operation complexity is reduced.

Optionally, that the selection unit 604 is configured to select one of at least two stored comparison data blocks as a reference data block includes: the selection unit 604 is configured to select, from the at least two comparison data blocks as the reference data block, a comparison data block that has a largest quantity of sub-data blocks the same as those in the to-be-stored data block. Further, the selection unit 604 may select a comparison data block that has a largest quantity of sub-data blocks the same as those in the to-be-stored data block and that has a smallest quantity of clusters of different sub-data blocks as the reference data block. A cluster of different sub-data blocks is a set of different sub-data blocks that are continuous in locations, and sub-data blocks at adjacent locations of the set are same sub-data blocks.

The to-be-stored data block is compared with multiple comparison data blocks, so that a similarity between each comparison data block and the to-be-stored data block can be determined. A comparison data block that has a largest quantity of sub-data blocks the same as those in the to-be-stored data block is a data block that has a highest similarity with the to-be-stored data block. Further, a comparison data block that has a smallest quantity of clusters of different sub-data blocks is selected as the reference data block from comparison data blocks that have a highest similarity with the to-be-stored data block, so that information required for recording locations of different sub-data blocks can be reduced, and a deduplication operation compression ratio is further increased.

Optionally, that the selection unit 604 is configured to select a representative sub-data block of the first sub-data block includes: the selection unit 604 is configured to select a reference sub-data block that is corresponding to a location identifier that is corresponding to each first sub-data block as the representative sub-data block of the first sub-data block.

Data blocks stored in a database have a higher similarity with each other, and a same part of different data blocks generally has a same relative location in the data blocks. Therefore, the reference sub-data block that is corresponding to the location identifier that is corresponding to each first sub-data block is selected as the representative sub-data block of the first sub-data block, so that a large quantity of continuous “0s” can appear in an XOR result, and a run-length encoding compression ratio is greatly reduced.

Optionally, that the selection unit 604 is configured to select a representative sub-data block of the first sub-data block includes: the selection unit 604 is configured to: separately perform an XOR operation on the first sub-data block and at least two stored sub-data blocks by using the XOR unit, and select a stored sub-data block as the representative sub-data block according to run-length encoding compression ratios of results of the XOR operations, where a result of XOR operations performed on the stored sub-data block and the first sub-data block has a smallest run-length encoding compression ratio.

The stored sub-data block is selected as the representative sub-data block from stored sub-data blocks by means of comparison, where a result of an XOR operation performed on the first sub-data block and the stored sub-data block has the smallest run-length encoding compression ratio, so that storage space required for storing the to-be-stored data block can be reduced to a relatively large extent.

Optionally, that the selection unit 604 is configured to select a representative sub-data block of the first sub-data block includes: the selection unit 604 is configured to: perform an XOR operation on every two first sub-data blocks by using the XOR unit, and select a first sub-data block as the representative sub-data block according to run-length encoding compression ratios of results of the XOR operations, where a result of XOR operations performed on the first sub-data block and another first sub-data block has a smallest run-length encoding compression ratio.

The first sub-data blocks are searched for the first sub-data block that has a highest similarity with the another first sub-data block, and the first sub-data block is used as the representative sub-data block, so that storage space required for storing the to-be-stored data block can be reduced without depending on stored sub-data blocks.

To determine an optimal value of N, the selection unit 604 is further configured to: extract a sample from to-be-stored data, separately determine a storage compression ratio, a storage speed, and a read speed of the sample according to different to-be-stored sub-data block sizes, and determine a value of N according to a size of a sub-data block with a smallest storage compression ratio if the storage speed and the read speed meet a constraint condition. The constraint condition is that the storage speed is greater than or equal to a preset first threshold, and the read speed is greater than or equal to a preset second threshold.

A most proper data block division method is selected by extracting the sample, so that storage space required for storing the to-be-stored data block can be reduced to a greatest extent when the storage processing speed and the read processing speed are met.

Optionally, the comparison unit 606 is further configured to store a fingerprint of the first sub-data block. Therefore, when the first sub-data block is subsequently used as a reference sub-data block of another data block, there is no need to repeatedly calculate the fingerprint.

This embodiment of the present application is an apparatus embodiment corresponding to the method 300, and some feature descriptions in the embodiment of the method 300 are applicable to this embodiment of the present application. Details are not described herein again.

According to the technical solution disclosed in the present application, according to features of data similarity and location correlation in a database, a to-be-stored data block is divided into sub-data blocks of a smaller granularity, sub-data blocks that are of the to-be-stored data block and a reference data block and that are at a same location are compared, a deduplication operation is performed on same sub-data blocks with a relatively small calculation amount, an XOR operation is performed on a sub-data block and a reference sub-data block that are different from each other, and run-length encoding compression is performed on an XOR result. Therefore, storage space required for recording the to-be-stored data block is greatly reduced.

In the several embodiments provided in this application, it should be understood that the disclosed system, device, and method may be implemented in other manners. For example, the described apparatus embodiment is merely an example. For example, the module division is merely logical function division and may be other division during actual implementation. For example, multiple modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate parts may or may not be physically separate, and parts displayed as modules may or may not be physical modules, may be located in one position, or may be distributed on a plurality of network modules. Some or all the modules may be selected according to actual needs to achieve the objectives of the solutions of the embodiments.

In addition, functional modules in the embodiments of the present application may be integrated into one processing module, or each of the modules may exist alone physically, or two or more modules are integrated into one module. The integrated module may be implemented in a form of hardware, or may be implemented in a form of hardware in addition to a software functional module.

When the foregoing integrated module is implemented in a form of a software functional module, the integrated unit may be stored in a computer-readable storage medium. The software functional module is stored in a storage medium and includes several instructions for instructing a computer device (which may be a personal computer, a server, or a network device) to perform some of the operations of the methods described in the embodiments of the present application. The foregoing storage medium includes any medium that can store program code, such as a USB flash drive, a removable hard disk, a ROM, a RAM, a magnetic disk, or an optical disc.

Finally, it should be noted that the foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present application.

What is claimed is:

1. A data storage method, performed by a storage apparatus, comprising:
dividing a data block to be stored into N equal-sized sub-data blocks corresponding to N location identifiers, wherein each sub-data block corresponds to one location identifier, and N is a positive integer greater than 1;
selecting one of at least two data blocks stored in the storage apparatus as a reference data block, wherein the reference data block comprises N reference sub-data blocks, the N reference sub-data blocks corresponding to the N location identifiers, and each reference sub-data block corresponding to one location identifier;
comparing a sub-data block corresponding to an i^{th} location identifier and a reference sub-data block corresponding to the i^{th} location identifier, and determining a first sub-data block in the N sub-data blocks, wherein i is a positive integer progressively increasing from 1 to N, and the first sub-data block is a sub-data block different from a reference sub-data block compared with the first sub-data block;
selecting a representative sub-data block of the first sub-data block;
performing an exclusive OR (XOR) operation on data of the first sub-data block and data of the representative sub-data block; and
compressing a result of the XOR operation using run-length encoding, and storing a compression result and location information of the first sub-data block in the storage apparatus.

2. The method according to claim 1, further comprising:
determining a second sub-data block in the N sub-data blocks, wherein the second sub-data block is a sub-data block identical to a reference sub-data block compared with the second sub-data block; and
performing a deduplication operation on the second sub-data block.

3. The method according to claim 1, wherein comparing the sub-data block corresponding to the i^{th} location identifier and the reference sub-data block corresponding to the i^{th} location identifier comprises:
comparing a fingerprint of the sub-data block corresponding to the i^{th} location identifier and a fingerprint of the reference sub-data block corresponding to the i^{th} location identifier, wherein same fingerprints indicate that the sub-data block is the same as the reference sub-data block, and different fingerprints indicate that the sub-data block is different from the reference sub-data block.

4. The method according to claim 1, wherein selecting the reference data block comprises: selecting a stored data block, which comprises a largest quantity of same sub-data blocks with the to-be-stored data block, from the at least two stored data blocks as the reference data block.

5. The method according to claim 1, wherein selecting the representative sub-data block of the first sub-data block comprises: selecting a reference sub-data block corresponding to the same location identifier with the first sub-data block as the representative sub-data block of the first sub-data block.

6. The method according to claim 1, wherein selecting the representative sub-data block of the first sub-data block comprises:
separately performing an XOR operation on the first sub-data block and at least two stored sub-data blocks; and
selecting a stored sub-data block as the representative sub-data block according to run-length encoding compression ratios of results of the XOR operations, wherein a result of the XOR operations performed on the representative sub-data block and the first sub-data block has a smallest run-length encoding compression ratio.

7. The method according to claim 1, wherein selecting the representative sub-data block of the first sub-data block comprises:
performing an XOR operation on every two first sub-data blocks; and
selecting a first sub-data block as the representative sub-data block according to run-length encoding compression ratios of results of the XOR operations, wherein a result of the XOR operations performed on the representative sub-data block and another first sub-data block has a smallest run-length encoding compression ratio.

8. The method according to claim 1, wherein before dividing the data block into N equal-sized sub-data blocks, the method further comprises:
extracting a sample from data to be stored, separately determining a storage compression ratio, a storage speed, and a read speed of the sample according to different sub-data block sizes; and
determining a value of N according to a size of a sub-data block with a smallest storage compression ratio if the storage speed and the read speed satisfy a constraint condition, wherein the constraint condition is that the storage speed is greater than or equal to a first preset threshold, and the read speed is greater than or equal to a second preset threshold.

9. The method according to claim 3, further comprising: storing a fingerprint of the first sub-data block in the storage apparatus.

10. A storage apparatus, comprising:
a processor; and
a non-transitory computer-readable storage medium coupled to the processor and storing programming instructions for execution by the processor, the programming instructions instruct the processor to:
divide a data block to be stored into N equal-sized sub-data blocks corresponding to N location identifiers, wherein each sub-data block corresponds to one location identifier, and N is a positive integer greater than 1;
select one of at least two data blocks stored in the storage apparatus as a reference data block, wherein the reference data block comprises N reference sub-data blocks, the N reference sub-data blocks correspond to the N location identifiers, and each reference sub-data block corresponds to one location identifier;
compare a sub-data block corresponding to an i^{th} location identifier and a reference sub-data block corresponding to the i^{th} location identifier, and determining a first sub-data block in the N sub-data blocks, wherein i is a positive integer progressively increasing from 1 to N, and the first sub-data block is a sub-data block different from a reference sub-data block compared with the first sub-data block;
select a representative sub-data block of the first sub-data block;
perform an exclusive OR (XOR) operation on data of the first sub-data block and data of the representative sub-data block; and
compress a result of the XOR operation using run-length encoding, and storing a compression result and location information of the first sub-data block.

11. The storage apparatus according to claim 10, wherein the processor is further configured to:
determine a second sub-data block in the N sub-data blocks, wherein the second sub-data block is a sub-data block identical to a reference sub-data block compared with the second sub-data block; and
perform a deduplication operation on the second sub-data block.

12. The storage apparatus according to claim 10, wherein in comparing the sub-data block corresponding to the i^{th} location identifier and the reference sub-data block corresponding to the i^{th} location identifier, the processor is further configured to compare a fingerprint of the sub-data block corresponding to the i^{th} location identifier and a fingerprint of the reference sub-data block corresponding to the i^{th} location identifier, wherein same fingerprints indicate that the sub-data block is the same as the reference sub-data block, and different fingerprints indicate that the sub-data block is different from the reference sub-data block.

13. The storage apparatus according to claim 10, wherein in selecting the reference data block, the processor is further configured to select a stored data block, which comprises a largest quantity of same sub-data blocks with the data block, from the at least two stored data blocks as the reference data block.

14. The storage apparatus according to claim 10, wherein in selecting the representative sub-data block of the first sub-data block, the processor is further configured to select a reference sub-data block corresponding to the same location identifier with the first sub-data block as the representative sub-data block of the first sub-data block.

15. The storage apparatus according to claim 10, wherein in selecting the representative sub-data block of the first sub-data block, the processor is further configured to separately perform an XOR operation on the first sub-data block and at least two stored sub-data blocks, and select a stored sub-data block as the representative sub-data block according to run-length encoding compression ratios of results of the XOR operations, wherein a result of the XOR operations performed on the representative sub-data block and the first sub-data block has a smallest run-length encoding compression ratio.

16. The storage apparatus according to claim 10, wherein in selecting the representative sub-data block of the first sub-data block, the processor is further configured to perform an XOR operation on every two first sub-data blocks, and select a first sub-data block as the representative sub-data block according to run-length encoding compression ratios of results of the XOR operations, wherein a result of the XOR operations performed on the representative sub-data block and another first sub-data block has a smallest run-length encoding compression ratio.

17. The storage apparatus according to claim 10, before dividing the data block into N equal-sized sub-data blocks, the processor is further configured to:
extract a sample from data to be stored;
separately determine a storage compression ratio, a storage speed, and a read speed of the sample according to different sub-data block sizes; and
determine a value of N according to a size of a sub-data block with a smallest storage compression ratio if the storage speed and the read speed satisfy a constraint condition, wherein the constraint condition is that the storage speed is greater than or equal to a first preset threshold, and the read speed is greater than or equal to a second preset threshold.

18. The storage apparatus according to claim 12, wherein the processor is further configured to store a fingerprint of the first sub-data block.

19. A non-transitory machine-readable medium having instructions stored therein, which when executed by a processor, cause the processor to perform operations, the operations comprising:
dividing a data block to be stored into N equal-sized sub-data blocks corresponding to N location identifiers, wherein each sub-data block corresponds to one location identifier, and N is a positive integer greater than 1;
selecting one of at least two data blocks stored in the storage apparatus as a reference data block, wherein the reference data block comprises N reference sub-data blocks, the N reference sub-data blocks corresponding to the N location identifiers, and each reference sub-data block corresponding to one location identifier;
comparing a sub-data block corresponding to an i^{th} location identifier and a reference sub-data block corresponding to the i^{th} location identifier, and determining a first sub-data block in the N sub-data blocks, wherein i is a positive integer progressively increasing from 1 to N, and the first sub-data block is a sub-data block different from a reference sub-data block compared with the first sub-data block;
selecting a representative sub-data block of the first sub-data block;
performing an exclusive OR (XOR) operation on data of the first sub-data block and data of the representative sub-data block; and
compressing a result of the XOR operation using run-length encoding, and storing a compression result and location information of the first sub-data block in the storage apparatus.

20. The machine-readable medium according to claim 19, wherein the opeerations further comprise:
determining a second sub-data block in the N sub-data blocks, wherein the second sub-data block is a sub-data block identical to a reference sub-data block compared with the second sub-data block; and
performing a deduplication operation on the second sub-data block.
